(19) United States
(12) Patent Application Publication
(10) Pub. No.: US 2009/0063199 A1
(43) Pub. Date: Mar. 5, 2009

(54) MARRIAGE OBLIGATION FULFILLMENT INSURANCE SYSTEM AND METHOD

(76) Inventors: Yung-Sung Chien, Taipei City (TW); Frank Kuen-Bao Ling, Kaohsiung County (TW)

Correspondence Address: NORTH AMERICA INTELLECTUAL PROPERTY CORPORATION, P.O. BOX 506, MERRIFIELD, VA, 22116, US

(21) Appl. No.: 12/203,107

(22) Filed: Sep. 2, 2008

(30) Foreign Application Priority Data
Aug. 31, 2007 (TW) 096132360
Jul. 18, 2008 (TW) 097127257

(51) Int. Cl. G06Q 40/00

(52) U.S. Cl. 705/4

(57) ABSTRACT

A marriage obligation fulfillment insurance method and system is implemented in the marriage insurance area of financial e-commerce. An insurance company using the method and system to incorporate a bid platform can remove interest risk and earn a service charge. The policy owner can expand his credit and investment during the insurance period of a marriage insurance contract set up with the insurance company. The marriage insurance contract will refrain the policy owner from getting divorced.

### BACKGROUND OF THE INVENTION

1. Field of the Invention

The present invention discloses a marriage obligation fulfillment insurance system and method.

2. Description of the Prior Art

As the society evolves, the rising of the divorce rate has become a concern in the global community. Taking Taiwan as an example, the crude divorce rate (the number of divorces occurring among the population of a given geographical area during a given year) in 2006 has reached 2.83%, which had risen 50% from ten years ago, meaning 177 couples get divorced in Taiwan every day, which had risen 48% from ten years ago. It was the fifth highest rate in the world, and the highest rate in Asia. The consequences of divorce must be dealt with in Taiwan society.

Regarding this problem, marriage insurance policies had been designed to reduce the impacts. For example, the UK, Hong Kong and some other countries had introduced marriage insurance related contracts. However, the contracts were mostly related to pre-marital contracts. Their contents were determined by both spouses, the children's rights were not protected. Instead of calling the contract as an insurance policy, it should be called a pre-marital agreement. Insurance benefit receiving from marriage is not as simple as that from death. Thus how to remove the moral hazard risk of fake marriage or fake divorce is the key determinant of a successful marriage insurance policy.

US patent application publication No. 2003/0200124, “Marriage Insurance” and No. 2007/0027724, “Divorce Insurance” disclose modifications of marriage insurance policies. However, none of these two publications has produced any breakthrough in the premium structure of insurance policies. The beneficiaries of such type insurance policies can only receive promised benefits from insurance companies, while those benefits cannot provide them enough protection.

U.S. Pat. No. 5,655,085, “Computer System for Automated Comparing of Universal Life Insurance Policies Based on Selectable Criteria” and US patent application publication No. 2004/0210460, “Marriage Insurance for Protecting against Divorce” disclose means to increase investment options of a unit-linked insurance policy and means to include investment in a marriage insurance policy. These two publications make improvement in the investment portion of a unit-linked insurance policy, but they are still under the structure of a traditional unit-linked insurance policy. When a policy owner faces an economic downturn, the policy owner still has to make investment continuously, being exposed to potential investment loss.

In response to the rising divorce rate, providing protection to children of a divorced couple is essential to social stability. However, none of the above marriage insurance policies provides sufficient protection to policy owners. Thus, how to protect the rights of policy owners has become an important and urgent issue.

### SUMMARY OF THE INVENTION

The present invention discloses a marriage obligation fulfillment insurance method. The method comprises handling an insurance premium paid by a policy owner according to a marriage insurance contract and whether the policy owner has executed a divorce, and calculating an amount of a deposit to be paid by the policy owner or processing the deposit according to the marriage insurance contract and whether the policy owner has executed the divorce.

The present invention further discloses a marriage obligation fulfillment insurance system. The marriage obligation fulfillment insurance system comprises a balance settlement module, an insurance premium management module, a self-determined interest platform, a joint account management module, an asset management module and an event confirmation and compensation module. The balance settlement module is for receiving an insurance premium and deposit according to a marriage insurance contract. The insurance premium management module is for processing the insurance premium according to whether the policy owner has executed a divorce. The self-determined interest platform is for determining a reserve and comparing a bid placed by the policy owner in the self-determined interest platform with the reserve to determine if the bid satisfies a winning bid criterion. The joint account management module is for processing the deposit and managing a joint account according to the deposit, a virtual account number of the policy owner in the joint account, whether the policy owner has executed the divorce, whether the bid satisfies the winning bid criterion, whether interest of the policy owner should be prepaid, and whether a bid duration of the self-determined interest platform has ended. The asset management module is for managing an asset management account wherein the asset management account is for depositing a total amount including a winning bid which satisfies the winning bid criterion. The event confirmation and compensation module is for issuing an insurance benefit corresponding to the insurance premium, a sum of deposits deposited by the policy owner in the joint account, or an amount accumulated in the asset management account to a beneficiary designated by the policy owner according to information provided by the insurance premium management module, joint account management module and asset management module. The cost of capital is determined according to reference capital supply, capital demand, interest rate, and short- and long-term interest rate variations of the self-determined interest platform.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 disclose a monetary management flow of the marriage obligation fulfillment insurance method according to the present invention.

FIG. 4 shows the calculation of the deposit in FIGS. 1-3.

FIG. 5 shows the calculations of the total amount and reimbursement in FIGS. 1-3.

FIG. 6 shows a system for supporting the marriage obligation fulfillment insurance method in FIGS. 1-5.

### DETAILED DESCRIPTION

To protect the rights of owners of marriage insurance policies, the present invention provides a marriage obligation fulfillment insurance method and a system for implementing the marriage obligation fulfillment insurance method.

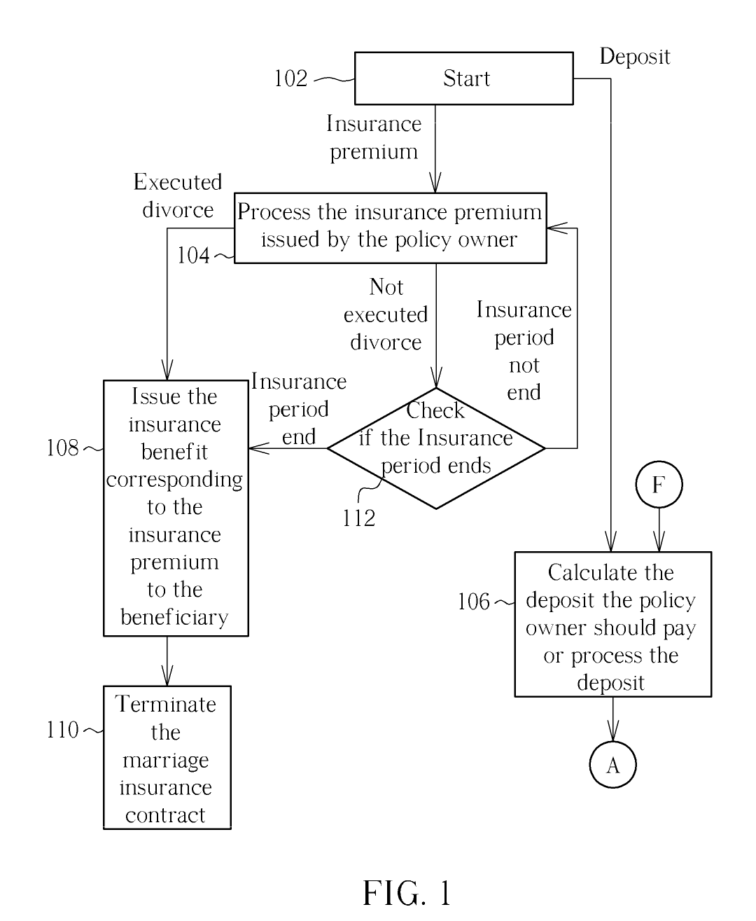

FIGS. 1-3 disclose a monetary management flow of the marriage obligation fulfillment insurance method according to the present invention. The monetary management flow is mainly focused on different processing methods of insurance premiums paid by a policy owner and deposits deposited by the policy owner. The process conditions comprise whether the policy owner has executed a divorce, whether the policy owner has placed a bid in a self-determined interest platform created by the marriage obligation fulfillment insurance method according to the present invention, and whether the bid satisfies a winning bid criterion, etc. Of the process conditions, whether the policy owner has executed a divorce is the most important condition because the purpose of the marriage obligation fulfillment insurance method according to the present invention is to reduce the divorce rate. Further through potential gain of asset management with the insurance, the said method intends to discourage the policy owner from getting divorced. When the policy owner accepts the marriage obligation fulfillment insurance method disclosed by the present invention and operated by an insurance company, the policy owner and the insurance company establish a marriage insurance contract to specify the rights and duties between the two parties. In other words, the embodiments of the marriage obligation fulfillment insurance method according to the present invention and the process conditions are also specified in the marriage insurance contract. Please note, besides the marriage insurance contract will be terminated after the following specific conditions are satisfied, the marriage insurance contract has an insurance period. When the insurance period is due, the marriage insurance contract is terminated. Moreover, the bid duration is divided into a plurality of periods of an equal length. The marriage obligation fulfillment insurance method according to the present invention performs a determination once per period during the bid duration. However the policy owner may execute a divorce at a time between two periods of the bid duration, such as between the nth period and the (n+1)th period where n is an integer. In this case, the divorce is treated as being executed in the nth period. Please note, unless otherwise specified the steps in FIGS. 1-3 are seen as occurring in the nth period. The marriage insurance contract also specifies a beneficiary designated by the policy owner. When the policy owner satisfies certain conditions specified in the marriage insurance contract so that the insurance company has to issue a corresponding insurance benefit, the insurance benefit should be issued to the beneficiary.

Steps 104, 108, 110, 112 disclose methods of processing the premium paid by the policy owner according to the present invention. In step 104, the insurance premium is handled according to whether the policy owner has executed the divorce. If the policy owner has executed the divorce in the nth period, as shown in step 108, the insurance company will issue an insurance benefit to the beneficiary according to the marriage insurance contract. The amount of the insurance benefit is recorded in the marriage insurance contract. Please note, the amount of the insurance benefit is calculated and recorded in the marriage insurance contract by the insurance company according to the periodic insurance premium agreed to be paid by the policy owner. When the insurance benefit is issued, if not considering other conditions generated between the policy owner and the insurance company according to whether the bid satisfies the winning bid criterion, then the marriage insurance contract can be terminated in Step 110. Further in Step 104, if the policy owner has not executed the divorce in the nth period, then check if the nth period is the ending term of the insurance period set in the marriage insurance contract. If the nth period is the ending term of the bid duration, then perform Step 108 and Step 110 to terminate the marriage insurance contract; or else perform Step 104 to process the premium according to whether the policy owner executes the divorce in the (n+1)th period or not.

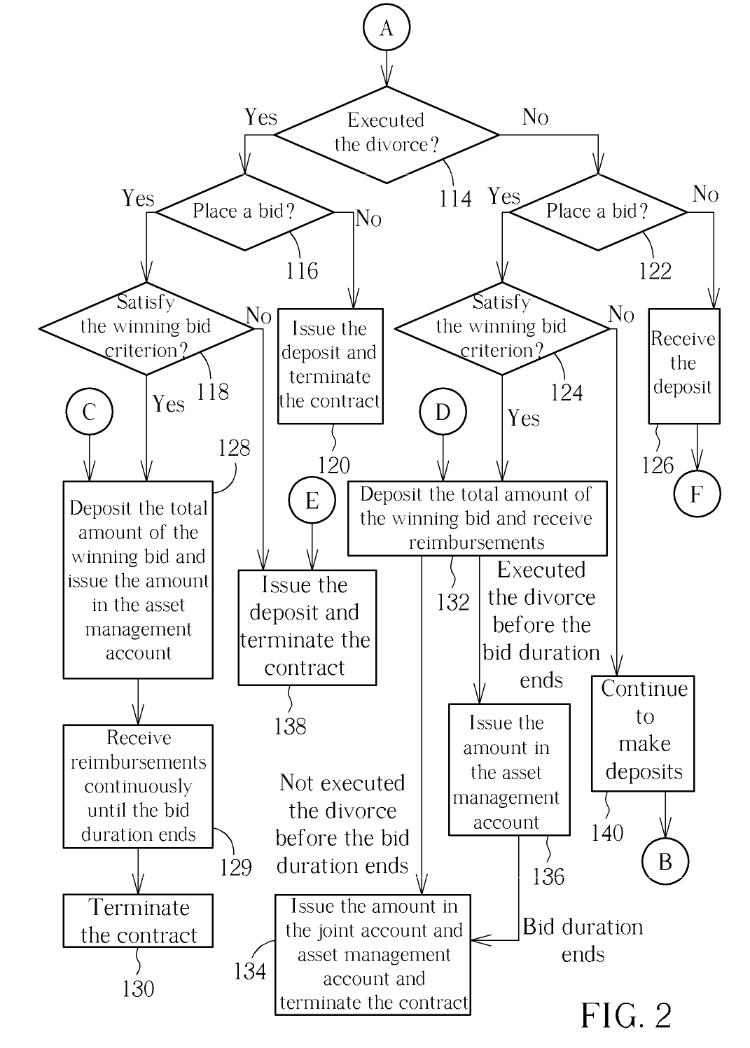

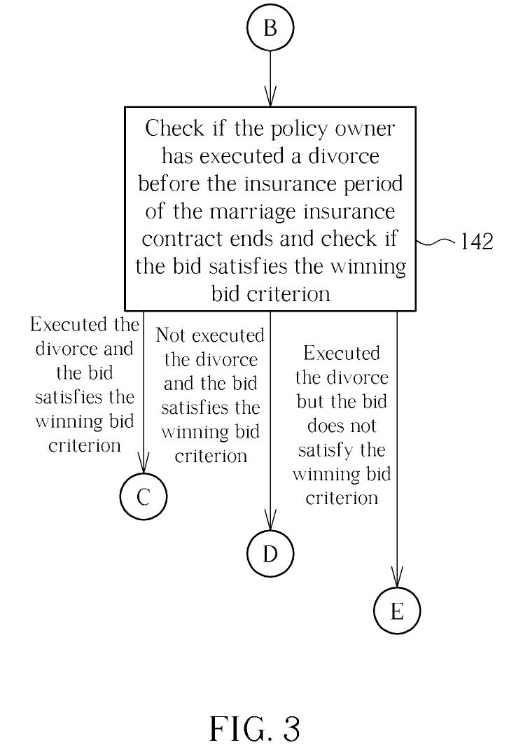

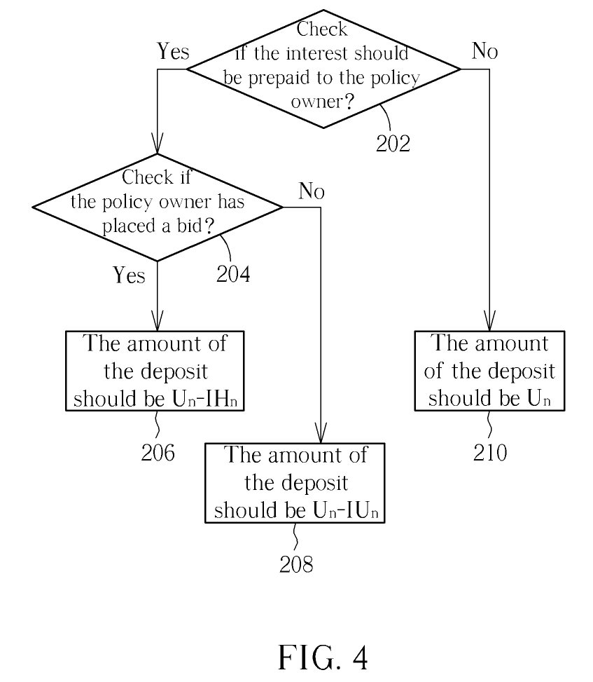

Step 106 and the steps in FIGS. 2 and 3 are related to deposits made by the policy owner during the insurance period of the marriage insurance contract. The insurance company calculates the required periodic deposit of the policy owner according to the conditions specified in the marriage insurance contract, whether the policy owner has placed a bid in the self-determined interest platform, and whether the bid corresponding to the deposit satisfies the winning bid criterion. The insurance company will deposit the policy owner's deposit in a joint account every period. The system will set up a virtual account number of the joint account when the marriage insurance contract is set up. The joint account will be managed by the insurance company, and different policy owners will be given different virtual account numbers. First in Step 106, the marriage obligation fulfillment insurance method according to the present invention calculates the required deposit of the policy owner in the nth period according to a predetermined method so as to determine the amount to be deposited into the joint account according to the virtual account number in the nth period. The predetermined method will be disclosed later in FIG. 4. Steps 114, 116, 122, 118, 124 determine how to process the remaining amount according to conditions such as whether the policy owner has executed the divorce, whether the policy owner has placed the bid in the self-determined interest platform, whether the bid satisfies the winning bid criterion, etc. Please note, except determining whether the policy owner has placed the bid in the self-determined interest platform should be done before determining whether the bid satisfies the winning bid criterion, embodiments generated by rearranging the sequence of steps corresponding to the foregoing three conditions still belong to the scope of the marriage obligation fulfillment insurance method according to the present invention. In other words, the marriage obligation fulfillment insurance method according to the present invention disclosed in FIGS. 1-3 is only a preferred embodiment of the present invention.

Steps 128, 129 and 130 mean that in the nth period, the policy owner has executed the divorce in Step 114, the policy owner has placed the bid in Step 116, and the bid satisfies the winning bid criterion of Step 118. At this time, the policy owner will receive a total amount of a winning bid because the bid satisfies the winning bid criterion. The insurance company will open an asset management account for the policy owner and deposit the total amount into the asset management account. Theoretically the insurance company should invest the money in the asset management account to maximize the profit of the beneficiary or policy owner. However since the policy owner has executed the divorce, in the nth period, the insurance company not only has to issue the insurance benefit to the beneficiary according to the marriage insurance contract, but the total amount should also be withdrawn to the beneficiary from the asset management account. However because the bid of the policy owner satisfies the bidding criterion, the policy owner has to make reimbursements until a bid duration in the self-determined interest platform has ended. Please note, the bid duration in the self-determined interest platform is determined when the marriage insurance contract is set up. The bid duration and the insurance period of the marriage insurance contract are independent of each other. When the bid of the policy owner satisfies the bidding criterion, unless the bid duration is ended and the policy owner has reimbursed all amounts, the policy owner still cannot terminate the marriage insurance contract due to the amount owing. Steps 128, 129 and 130 refer to a situation in which the divorce is executed in the same period as the bid satisfying the winning criterion. The chance of this occurrence is not high, but still has to be considered to regulate the dealing of money between the policy owner and the insurance company.

Step 138 means that in the nth period, the policy owner has executed the divorce in Step 114, the policy owner has placed the bid in Step 116, but the bid does not satisfy the winning criterion of the self-determined interest platform. Because the policy owner has executed the divorce, the insurance company should not only issue the insurance benefit to the beneficiary, but should also issue a sum of deposits deposited by the policy owner so far in the asset management account with interest to the beneficiary. Because the bid placed by the policy owner does not satisfy the winning criterion of the self-determined interest platform, the balance between the policy owner and the insurance company is settled, and the marriage insurance contract can be ended successfully.

Step 120 means that in the nth period, the policy owner has executed the divorce in Step 114, but has not placed the bid in Step 116. Because the policy owner has not placed the bid nor won the bid, except the insurance benefit, the insurance company only needs to pay the beneficiary a sum of deposits deposited into the joint account according to the virtual account number by the policy owner so far with interest. Then the marriage insurance contract can be terminated.

Steps 132, 134 and 136 refer to that in the nth period, the policy owner has not executed the divorce in Step 114, the policy owner has placed the bid in the self-determined interest platform in Step 122, and the bid satisfies the winning criterion of the self-determined interest platform in Step 124. Because the bid satisfies the winning criterion, the insurance company will set up an asset management account, and deposit a total amount of the winning bid to the asset management account to make investments. From the (n+1)th period to the end of the bid duration in the self-determined interest platform, regardless whether the policy owner has executed the divorce or not, the policy owner has to make periodic reimbursements to the insurance company, and the marriage insurance contract can be terminated only after the bid duration has ended. However if the policy owner has executed the divorce during the (n+1)th period and the end of the bid duration, the insurance company should issue the insurance benefit according to the marriage insurance contract, and withdraw the total amount accumulated by the policy owner in the asset management account to the beneficiary. The marriage insurance contract can be terminated only after the bid duration has ended. Contrarily, if the policy owner has not executed the divorce during the (n+1)th period and the end of the bid duration, the total amount accumulated by the policy owner in the asset management account can be withdrawn to the beneficiary at the end of the bid duration, and then the marriage insurance contract can be terminated.

Step 140 means that in the nth period, the policy owner has not executed the divorce in Step 114, the policy owner has placed the bid in the self-determined interest platform in Step 122, and the bid does not satisfy the winning criterion of the self-determined interest platform in Step 124. In the nth period, the policy owner's deposit is deposited into the joint account according to the virtual account number. Then go to Step 142 to enter the (n+1)th period. Please note, Step 142 is for determining whether the condition of Step 140 has changed. In other words, if the execution time of Step 142 is from the (n+1)th period to the kth period where k is an integer not smaller than (n+1) and the kth period does not exceed the bid duration of the marriage insurance contract, the condition changes of the kth period may be in one of the following situations: (1) the policy owner changes from not having executed the divorce to having executed the divorce, and the bid placed by the policy owner changes from not satisfying the winning criterion to satisfying the winning criterion; (2) the policy owner still has not executed the divorce, but the bid placed by the policy owner changes from not satisfying the winning criterion to satisfying the winning criterion; (3) the policy owner changes from not having executed the divorce to having executed the divorce, but the bid placed by the policy owner still does not satisfy the winning criterion. Situation (1) satisfies the condition of Step 128, situation (2) satisfies the condition of Step 132, and situation (3) satisfies the condition of Step 138. Thus Step 142 can continue the marriage obligation fulfillment insurance method according to the present invention in Step 128, 132 or 138 according to the condition change of the kth period.

Step 126 means that in the nth period, the policy owner has not executed the divorce in Step 114, and the policy owner has not placed the bid in Step 116. At this time, the insurance company should deposit the policy owner's deposit in the joint account according to the virtual account number, and execute Step 106 again for the (n+1)th period.

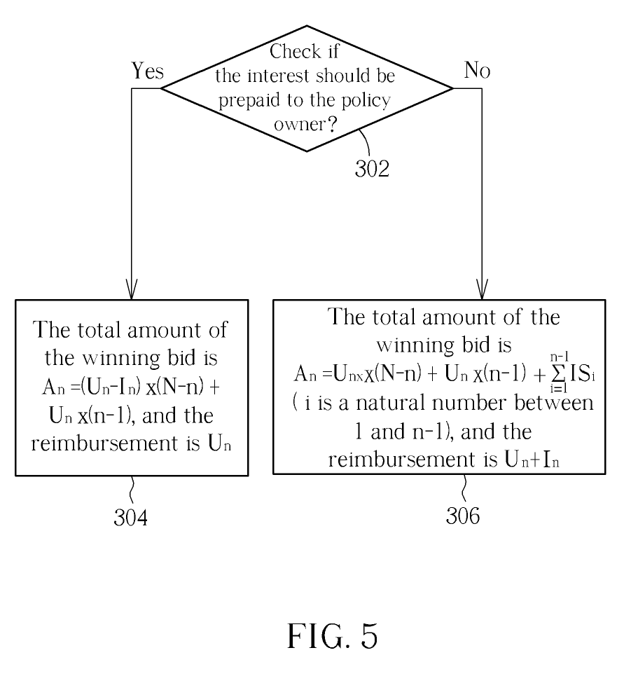

In the monetary management flow of FIGS. 1-3, although the calculations of the deposit, total amount and reimbursement are processed simultaneously with the monetary management flow, to make the explanations of the monetary management flow more clear, the calculations are illustrated in FIGS. 4 and 5. The relationships of the monetary management flow and the steps of FIGS. 4 and 5 are explained hereinafter. FIG. 4 shows the calculation of the deposit in FIGS. 1-3. FIG. 5 shows the calculations of the total amount and reimbursement in FIGS. 1-3. Please note, whether the policy owner has executed the divorce is only relevant to if the insurance benefit should be issued, not relevant to the amount of the insurance benefit, thus whether the policy owner has executed the divorce is not shown as a condition. And still, FIGS. 4 and 5 are consistent with FIGS. 1-3.

Please refer to FIG. 4. In FIG. 4, n is the period number of the current bid in the self-determined interest platform, which is referred to as the nth period above. Uₙ is an upper bid limit of the nth period in the self-determined interest platform. IHₙ is the highest bid placed by the policy owner in the nth period. IUₙ is the minimum bid required by the self-determined interest platform in the nth period. As shown in FIG. 4, factors which determine the amount of deposit include if interest should be prepaid to the policy owner, and if the policy owner has placed the bid in the self-determined interest platform. Moreover, the sequence of these two factors is not fixed. Thus an embodiment with their sequence switched is still within the scope of the present invention. FIG. 4 is only a preferred embodiment of the present invention. In Step 206, if interest should be prepaid to the policy owner, and the policy owner has placed the bid, then the amount deposited in the joint account is Uₙ−IHₙ in the nth period. In Step 208, if interest should be prepaid to the policy owner, and the policy owner has not placed the bid, then the amount deposited in the joint account is Uₙ−IUₙ in the nth period. In Step 210, if interest should be postpaid to the policy owner, regardless whether the policy owner has placed the bid or not, the amount deposited in the joint account is Uₙ in the nth period.

Please refer to FIG. 5. In FIG. 5, n is the period number of the current bid in the self-determined interest platform, which is referred to as the nth period above. The policy owner wins the bid in the nth period. Uₙ is an upper bid limit of the nth period in the self-determined interest platform. Aₙ is the total amount of the winning bid in the nth period. N is the number of total terms of the bid duration. In other words, the bid duration ends in the Nth period where n is smaller than N. Iₙ is the amount of the winning bid of the policy owner in the nth period. ISᵢ is a bid deposited by the policy owner to the self-determined interest platform in an ith period, and i is smaller than n. As shown in FIG. 5, the only condition to determine the total amount of the winning bid and the amount of the reimbursement is whether the interest is chosen to be prepaid or postpaid by the policy owner. In Step 304, if the policy owner chooses to have the interest prepaid, the total amount of the winning bid deposited to the asset management account would be Aₙ=(Uₙ−Iₙ)×(N−n)+Uₙ×(n−1), and the policy owner should reimburse Uₙ periodically from the (n+1)th period to the end of the bid duration to the insurance company. In Step 306, if the policy owner chooses to have the interest postpaid, the total amount of the winning bid deposited to the asset management account would be

$${A}_{n} = {U}_{n} \times ( N - n ) + {U}_{n} \times ( n - 1 ) + {\sum }_{i = 1}^{n - 1} {IS}_{i} = {U}_{n} \times ( N - 1 ) + {\sum }_{i = 1}^{n - 1} {IS}_{i} ,$$

and the policy owner should reimburse Uₙ+Iₙ periodically from the (n+1)th period to the end of the bid duration to the insurance company.

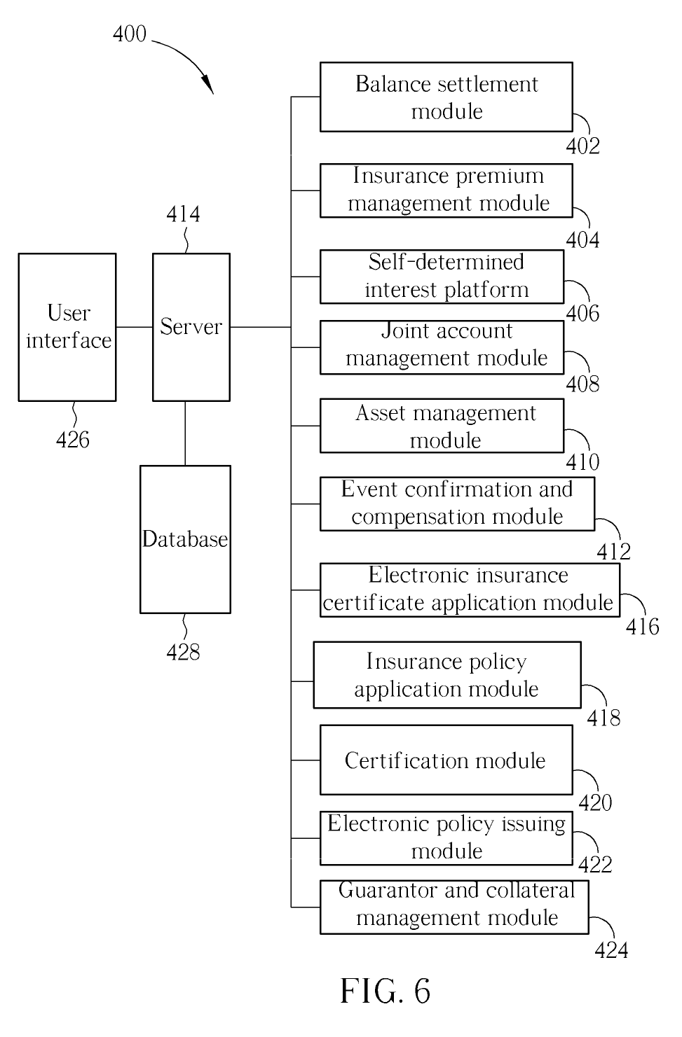

Please refer to FIG. 6 which shows a system for supporting the marriage obligation fulfillment insurance method in FIGS. 1-5. The marriage obligation fulfillment insurance system 400 comprises a balance settlement module 402, an insurance premium management module 404, a self-determined interest platform 406, a joint account management module 408, an asset management module 410, an event confirmation and compensation module 412, a server 414, an electronic insurance certificate application module 416, an insurance policy application module 418, a certification module 420, an electronic policy issuing module 422, a guarantor and collateral management module 424, a user interface 426 and a database 428.

The balance settlement module 402 is for receiving an insurance premium and deposit according to a marriage insurance contract established between the policy owner and the insurance company. The insurance premium management module 404 is for processing the insurance premium according to whether the policy owner has executed a divorce, and for supporting Steps 104, 108, 110 and 112 in FIG. 1. Moreover, the insurance premium management module 404 can calculate a reasonable insurance premium and insurance benefit according to the relationship between the insurance premium and insurance benefit. The self-determined interest platform 406 is for determining a cost of capital and comparing a bid placed by the policy owner in the self-determined interest platform 406 with the cost of capital to determine if the bid satisfies a winning bid criterion determined by the self-determined interest platform 406. Please note, the cost of capital is determined periodically according to reference capital supply, capital demand, interest rate, and short- and long-term interest rate variations of the self-determined interest platform 406. When the bid placed by the policy owner is no less than the cost of capital, the bid satisfies the bid criterion. The joint account management module 408 is for processing the deposit and managing a joint account according to the deposit, a virtual account number of the policy owner in the joint account, whether the policy owner has executed the divorce, whether the bid satisfies the winning bid criterion, whether interest of the policy owner should be prepaid, and whether a bid duration of the self-determined interest platform has ended, etc. In short, the joint account management module 408 is for performing the steps related to the deposit of the policy owner deposited to the joint account in FIGS. 1-4. The asset management module 410 is for managing an asset management account and a total amount of a winning bid deposited to the asset management module 410. The asset management module 410 also uses the total amount of the winning bid to make investments. In short, the asset management module 410 is used to perform steps related to the total amount including the winning bid in FIGS. 1-3 and 5. The event confirmation and compensation module 412 is for issuing an insurance benefit corresponding to the insurance premium, a sum of deposits deposited by the policy owner in the joint account, or an amount accumulated in the asset management account to a beneficiary designated by the policy owner according to information provided by the insurance premium management module 404, joint account management module 408 and asset management module 410. In other words, the event confirmation and compensation module 412 is used to perform the steps of issuing money to the beneficiary in FIGS. 1-3.

Other modules or elements of the care used to support more common functions of an insurance business system. In other words, replacing or updating the modules or elements is still within the scope of the present invention. For example, the server 414 is for coordinating information and financial transactions exchanged between each module of the marriage obligation fulfillment insurance system 400 and the self-determined interest platform 406. The electronic insurance certificate application module 416 is for receiving an electronic insurance certificate application from the policy owner and issuing an electronic insurance certificate to the policy owner, so that the policy owner can use the certificate for verification and implementing transactions. The insurance policy application module 418 is for receiving a policy application including the electronic insurance certificate so as to help the policy owner establish the marriage insurance contract. The certification module 420 is for certifying the policy application and verifying a financial status and credit of the policy owner. The electronic policy issuing module 422 is for issuing an electronic policy to the policy owner. The marriage insurance contract is recorded in the electronic policy. The guarantor and collateral management module 424 is for receiving credit information or a collateral provided by the policy owner, calculating a credit amount, and verifying if the credit amount is not smaller than a required bidding amount before placing the bid in the self-determined interest platform 406. The user interface 426 is a platform for communicating between the policy owner and the insurance company, and is for transmitting information between the policy owner and the server 414. The database 428 is for storing information according to the information and financial transactions exchanged between each module of the system 400 and the self-determined interest platform 406, such as the deposit, total amount including the winning bid, reimbursement, insurance premium etc.

From the descriptions of FIGS. 1-6, the marriage obligation fulfillment insurance method allows the policy owner to save money and make an investment through the marriage obligation fulfillment insurance system 400. The investment refers to saving and investment on top of the insurance benefit. The investment uses the total amount including the winning bid as a capital to invest in various financial products so as to maximize the capital gain of the policy owner. According to the aforementioned disclosure, from the perspective of the policy owner, the policy owner can set up a marriage insurance contract according to the marriage obligation fulfillment insurance system 400 provided by the insurance company, and receive additional gain from the periodic deposits deposited to the high interest joint account. If the policy owner is not satisfied with the gain from the deposits in the joint account, the policy owner can place a bid in the self-determined interest platform 406 every period. When a bid satisfies a winning bid criterion, the total amount including the winning bid then is deposited in an asset management account set up by the insurance company for the policy owner. The asset management method comprises the insurance company using the total amount including the winning bid to invest in financial products to maximize the gain of the policy owner and the beneficiary.

When the policy owner satisfies the condition for divorce specified in the marriage insurance contract, the insurance premium management module 404 will provide information to the event confirmation and compensation module 412 to issue an insurance benefit to a beneficiary designated by the policy owner. The joint account management module 408 will also provide information to the event confirmation and compensation module 412 so that as to issue the sum of deposits and interest of the policy owner in the joint account can be issued to the beneficiary to protect the rights of the beneficiary. Moreover, if the bid placed by the policy owner in the self-determined interest platform 406 satisfied the winning bid criterion, thus a total amount including the winning bid was remitted to the asset management account, the asset management module 410 will provide information to the event confirmation and compensation module 412 so that the event confirmation and compensation module 412 will issue the gain from the investment of the total amount of the winning bid in the asset management account to the beneficiary. However, the policy owner still has to make reimbursements to the insurance company until the bid duration determined by the self-determined interest platform 406 ends. Contrarily, if the policy owner does not satisfy the condition for divorce specified in the marriage insurance contract, the management of the insurance premium and deposit paid to the balance settlement module 402 by the policy owner shall continue to maintain the benefits of the policy owner and beneficiary as specified in the marriage insurance contract. Thus the policy owner can receive better investment gain from the marriage insurance contract and when a divorce is executed, the policy owner or the beneficiary can be protected.

A realistic example is illustrated hereinafter to explain the marriage obligation fulfillment insurance method and system 400. Chao and Sue were in love for many years and planned to get married. On their way to a wedding photo studio to take wedding photos, the studio provided them a marriage insurance contract of an insurance company. The marriage insurance contract is set up according to the marriage obligation fulfillment insurance method of the present invention. After the introduction of a salesperson, Chao and Sue decided to purchase the marriage insurance contract. After returning home, Chao entered a website set up according to the marriage obligation fulfillment insurance system 400 of the present invention through the user interface 426 and server 414 to purchase the marriage insurance contract from an insurance company. After passing electronic certification, Chao used the user interface 426 to fill out the policy application of the marriage insurance contract. The application was assumed to be used to apply for the following policy:

Marriage Obligation Fulfillment Insurance Policy

```
Policy contents:
    Policy owner: Chao
    Insured: children
    Beneficiary: children - first priority; Sue - second priority
    Insurance period: 7 years
    Insurance benefit: $100,000
    Insurance premium and deposit: $500 and deposit caused by
    each periodic bid
The policy owner of this insurance can place bids in the self-
determined interest platform of the insurance company. The
conditions are as follows:
    Bid duration: 7 years (once per month)
    Upper bid limit: $10,000
    Lower bid limit: calculated according to the floating rate of the
    2-year term deposit of the Post Office
```

The certification module 420 certified the policy application of the policy owner according to the above policy data, and the insurance premium management module 404 determined Chao's insurance benefit and his periodic insurance premium. In this example, the insurance benefit is assumed to be $100,000 and the periodic insurance premium is assumed to be $500. The purpose of the insurance benefit is to prevent fake marriage and fake divorce of the policy owner for the sake of defrauding the insurance benefit thereby reducing the ethical risk. After the certification module 420 certified the policy application, the electronic policy issuing module 422 generated Chao's personal electronic policy, recorded the marriage insurance contract in the electronic policy and sent the electronic policy to Chao to complete the process of purchasing the electronic policy. When Chao started to pay for the first periodic premium $500 and the deposit caused by the periodic bid to the balance settlement module 402, the electronic policy and the marriage insurance contract began to be effective. Please note, the marriage insurance contract had an insurance period, and the limited time was divided into a plurality of terms.

In each term of following plurality of terms, the $500 insurance premium was handled by the insurance premium management module 404. Part of the deposit generated by each periodic bid was deposited in the joint account according to the conditions in FIGS. 1-5 and was handled by the joint account management module 408. If Chao placed a bid in the self-determined interest platform 406 and the bid satisfied the winning bid criterion, then the total amount of the winning bid would be deposited to an asset management account. The asset management module 410 would make investments to increase the amount in the asset management account so as to expand the benefit of the policy owner and the beneficiary. Please note, the amount ($10,000) of the deposit would be the upper bid limit for placing a bid in the self-determined interest platform 406. In short, Chao's bid placed in the self-determined interest platform 406 could not exceed $10,000. Assume that Chao did not place any bid in the self-determined interest platform 406 within two years after the marriage insurance contract was set up, and the lower bid limit was $2000, then Chao could save $8000 ($2000 bid off the $100,000 upper bid limit) in the joint account. The total saving in two years (24 terms) was $192,000.

At the beginning of the third year after the marriage insurance contract was set up, Chao and Sue believed that the economy was recovering, and the performance of the investment invested by the insurance company was improving, they decided to use their periodic deposit to make additional investment. At this time, Chao mortgaged his residence to the guarantor and collateral management module 424. Please note, the collateral value of his residence should exceed the maximum amount he might receive from the self-determined interest platform 406 if he won the bid. The maximum amount he might receive was $10,000(the upper bid limit)×72(the number of terms)=$720,000. Assuming the assessed value of his residence was two million dollars, then the value of his residence was above the maximum amount he might receive if he won the bid. Thus the guarantor and collateral management module 424 would allow Chao to mortgage his residence and allow him to place a bid in the self-determined interest platform 406. Assume Chao placed a bid of $2,500 in the 25th term after the marriage insurance contract was set up, because the bid exceeded the cost of capital determined by the self-determined interest platform 406, and the bid satisfied the winning bid criterion of the self-determined interest platform 406, Chao could receive the total amount including the winning bid $592,500(=$7,500(bid off the upper bid limit)×47(the number of remaining terms of the marriage insurance contract)+$10,000(the periodic upper bid limit)×24(the number of previous terms)). Then the asset management module 410 deposited the total amount of the winning bid to an asset management account. With the agreement of Chao, the asset management module 410 could invest the total amount including the winning bid in various investment products such as mutual funds, structured notes, high rate term deposits, etc. provided by the insurance company to expand Chao's benefit from the total amount of the winning bid.

Suppose one year after purchasing the marriage insurance contract, Chao and Sue begot a girl, and designated the girl as the first beneficiary. And one year after the asset management module 410 started to use the total amount of the winning bid to make investments, Chao and Sue's relationship deteriorated and decided to get divorced. In the process of getting divorced, Sue became the guardian of the girl. At this time, Sue could use their divorce certificate to apply for compensation. When the event confirmation and compensation module 412 received the divorce certificate and information and verified the divorce, the event confirmation and compensation module 412 would issue $100,000 to the girl according to the information of the insurance premium management module 404. Suppose the year from the beginning of the investment of the asset management account to the divorce, the asset management module 410 generated 20% additional gain from the investment, the event confirmation and compensation module 412 would issue a sum $811,000 of the accumulated amount $711,000 and the insurance benefit $100,000 managed by the insurance premium management module 404 to the first beneficiary. And the sum would be managed by the girl's guardian Sue.

Though they were divorced, Chao still had to make periodic reimbursements due to his bid, or else his mortgaged residence would be auctioned. In other words, according to the marriage insurance contract, unless Chao reimbursed the remaining 35 periodic installments ($10,000/installment), the marriage insurance contract could not be terminated. However, Chao did not need to pay any more insurance premium. And when the bid duration was ended, the marriage insurance contract could be terminated.

In the above example, when comparing receiving an insurance benefit of $100,000 from paying the periodic insurance premium of $500 with receiving a potential asset of $811,000 from placing a bid in the marriage obligation fulfillment insurance system 400, making investment and receiving the insurance benefit, most people would obviously agree that receiving the potential asset is a lot more attractive than defrauding the insurance benefit. In other words, because the insurance benefit is far less attractive than the potential asset, people would not be tempted to defraud the insurance benefit, thus preventing people from getting a fake marriage for the sake of the insurance benefit, thereby removing the ethical risk of the marriage insurance.

The present invention discloses a marriage obligation fulfillment insurance system and method. It uses the benefit of the marriage insurance contract to restrain the policy owner from getting divorced, thus a divorce is unlikely to occur. By using the marriage obligation fulfillment insurance system and method, the policy owner can protect his children's financial needs. While taking care of his offsprings, the policy owner can earn interest from his savings or increase his capital gain through investment. The insurance company which utilizes the marriage obligation fulfillment insurance system and method is free from the risk of defrauding the insurance benefit through a fake marriage, thus reducing the possibility of negative spread.

Those skilled in the art will readily observe that numerous modifications and alterations of the device and method may be made while retaining the teachings of the invention.

What is claimed is:

1. A method of handling marriage insurance, the method comprising:
handling an insurance premium paid by a policy owner according to a marriage insurance contract and whether the policy owner has executed a divorce; and
calculating an amount of a deposit to be paid by the policy owner or processing the deposit according to the marriage insurance contract and whether the policy owner has executed the divorce.

2. The method of claim 1, wherein handling the insurance premium paid by the policy owner according to the marriage insurance contract and whether the policy owner has executed the divorce comprises:
issuing an insurance benefit corresponding to the insurance premium to a beneficiary when the policy owner executes the divorce; and
terminating the marriage insurance contract.

3. The method of claim 1, wherein handling the insurance premium paid by the policy owner according to the marriage insurance contract and whether the policy owner has executed the divorce comprises:
receiving the insurance premium from the policy owner during each payment term of an insurance period set in the marriage insurance contract when the policy owner has not executed the divorce until the insurance period ends or the policy owner executes the divorce within the time limit.

4. The method of claim 1, wherein calculating the amount of the deposit to be paid by the policy owner or processing the deposit according to the marriage insurance contract and whether the policy owner has executed the divorce comprises:
calculating the amount of the deposit or determining a total amount of a winning bid according to whether the policy owner has executed the divorce, whether the policy owner has placed a bid in a self-determined interest platform, and whether the bid corresponding to the deposit satisfies a winning bid criterion;
depositing the deposit in a joint account according to a virtual account number in the joint account corresponding to the policy owner; and
depositing the total amount of the winning bid in an asset management account belonging to the policy owner when the policy owner places the bid and the bid satisfies the winning bid criterion.

5. The method of claim 4, wherein the bid is determined to satisfy the winning bid criterion when the bid is no less than a cost of capital of the self-determined interest platform, the cost of capital being determined according to reference capital supply, capital demand, interest rate, and short- and long-term interest rate variations of the self-determined interest platform.

6. The method of claim 4, wherein calculating the amount of the deposit or determining the total amount including the winning bid according to whether the policy owner has executed the divorce, whether the policy owner has placed the bid in the self-determined interest platform, and whether the bid corresponding to the deposit satisfies the winning bid criterion comprises:
if the policy owner has placed the bid in the self-determined interest platform and the bid does not satisfy the winning bid criterion, calculating the amount of the deposit according to whether interest should be prepaid; and
depositing the deposit in the joint account according to the virtual account number.

7. The method of claim 4, wherein calculating the amount of the deposit or determining the total amount including the winning bid according to whether the policy owner has executed the divorce, whether the policy owner has placed the bid in the self-determined interest platform, and whether the bid corresponding to the deposit satisfies the winning bid criterion comprises:
if the policy owner has not placed the bid in the self-determined interest platform, calculating the amount of the deposit according to whether interest should be prepaid; and
depositing the deposit in the joint account according to the virtual account number.

8. The method of claim 4, wherein calculating the amount of the deposit or determining the total amount including the winning bid according to whether the policy owner has executed the divorce, whether the policy owner has placed the bid in the self-determined interest platform, and whether the bid corresponding to the deposit satisfies the winning bid criterion comprises:
if the policy owner has placed the bid in the self-determined interest platform and the bid satisfies the winning bid criterion, determining the total amount of the winning bid according to whether interest should be prepaid;
depositing the total amount including the winning bid in the asset management account; and
after the bid satisfies the winning bid criterion, at each term during a bid duration of the self-determined interest platform, receiving a reimbursement from the policy owner corresponding to the total amount of the winning bid until a number of reimbursements promised to the self-determined interest platform by the policy owner has achieved;
wherein the reimbursements are determined according to whether the interest should be prepaid.

9. The method of claim 8 wherein if the policy owner has placed the bid in the self-determined interest platform and the bid satisfies the winning bid criterion, determining the total amount including the winning bid according to whether the interest should be prepaid comprises:
if the interest should be prepaid, determining the total amount including the winning bid by:
Aₙ=(Uₙ−Iₙ)×(N−n)+Uₙ×(n−1);
wherein n is a term number of a current bid in the self-determined interest platform, the policy owner wins the bid in an nth term; Uₙ is an upper bid limit of the nth term in the self-determined interest platform; Aₙ is the total amount of the winning bid in the nth term; N is the total terms of the bid duration, and n is smaller than N; Iₙ is the amount of the winning bid of the policy owner in the nth term; and
wherein an amount of the reimbursement is Uₙ.

10. The method of claim 8 wherein if the policy owner has placed the bid in the self-determined interest platform and the bid satisfies the winning bid criterion, determining the total amount of the winning bid according to whether the interest should be prepaid comprises:
if the interest should be postpaid, the total amount of the winning bid is determined by:
$${A}_{n} = {U}_{n} \times ( N - n ) + {U}_{n} \times ( n - 1 ) + {\sum }_{i = 1}^{n - 1} {IS}_{i} ;$$
wherein n is a term number of a current bid in the self-determined interest platform, the policy owner wins the bid in an nth term; Uₙ is an upper bid limit of the nth term in the self-determined interest platform; Aₙ is the total amount including the winning bid in the nth term; N is the total terms of the bid duration, and n is smaller than N; ISᵢ is a bid deposited by the policy owner in the self-determined interest platform in an ith term, and i is smaller than n; Iₙ is the amount of the winning bid of the policy owner in the nth term; and
wherein an amount of the reimbursement is Uₙ+Iₙ.

11. The method of claim 4, wherein calculating the amount of the deposit to be paid by the policy owner or processing the deposit according to the marriage insurance contract and whether the policy owner has executed the divorce further comprises:
if the policy owner has executed the divorce, the policy owner has placed the bid in the self-determined interest platform, and the bid satisfies the winning bid criterion, issuing a sum of deposits deposited by the policy owner so far in the asset management account to a beneficiary designated by the policy owner;
receiving reimbursements paid by the policy owner continuously until a bid duration of the self-determined interest platform ends; and
terminating the marriage insurance contract.

12. The method of claim 4, wherein calculating the amount of the deposit to be paid by the policy owner or processing the deposit according to the marriage insurance contract and whether the policy owner has executed the divorce further comprises:
if the policy owner has not executed the divorce, the policy owner has placed the bid in the self-determined interest platform, and the bid satisfies the winning bid criterion, receiving reimbursements paid by the policy owner continuously until a bid duration of the self-determined interest platform ends or until the policy owner executes the divorce if the divorce is executed before the bid duration ends;
wherein when the bid duration ends, the marriage insurance contract is terminated.

13. The method of claim 12 further comprising:
if the policy owner has executed the divorce before the bid duration ends, issuing a sum of deposits deposited by the policy owner so far in the asset management account to a beneficiary designated by the policy owner; and
when the bid duration ends, terminating the marriage insurance contract.

14. The method of claim 4, wherein calculating the amount of the deposit to be paid by the policy owner or processing the deposit according to the marriage insurance contract and whether the policy owner has executed the divorce further comprises:
if the policy owner has executed the divorce, the policy owner has placed the bid in the self-determined interest platform, and the bid does not satisfy the winning bid criterion, issuing a sum of deposits deposited by the policy owner so far in the asset management account to a beneficiary designated by the policy owner, and terminating the marriage insurance contract.

15. The method of claim 4, wherein calculating the amount of the deposit to be paid by the policy owner or processing the deposit according to the marriage insurance contract and whether the policy owner has executed the divorce further comprises:
if the policy owner has not executed the divorce, the policy owner has placed the bid in the self-determined interest platform, and the bid does not satisfy the winning bid criterion, depositing deposits in the joint account according to the virtual account number continuously until the policy owner executes the divorce before an insurance period set in the marriage insurance contract ends or the bid satisfies the winning bid criterion.

16. The method of claim 15 wherein if the policy owner has not executed the divorce, the policy owner has placed the bid in the self-determined interest platform, and the bid does not satisfy the winning bid criterion, depositing the deposits in the joint account according to the virtual account number continuously until the policy owner executes the divorce before the insurance period set in the marriage insurance contract ends or the bid satisfies the winning bid criterion comprises:
when the policy owner changes to execute the divorce, the policy owner has placed the bid in the self-determined interest platform, and the bid changes to satisfy the winning bid criterion, issuing a sum of deposits deposited by the policy owner so far in the asset management account to a beneficiary designated by the policy owner;
receiving reimbursements paid by the policy owner continuously until the bid duration ends; and
terminating the marriage insurance contract.

17. The method of claim 15 wherein if the policy owner has not executed the divorce, the policy owner has placed the bid in the self-determined interest platform, and the bid does not satisfy the winning bid criterion, depositing the deposits in the joint account according to the virtual account number continuously until the policy owner executes the divorce before the insurance period set in the marriage insurance contract ends or the bid satisfies the winning bid criterion comprises:
if the policy owner has not executed the divorce, the policy owner has placed the bid in the self-determined interest platform, and the bid changes to satisfy the winning bid criterion, receiving reimbursements paid by the policy owner continuously until the bid duration ends, or until the policy owner executes the divorce if the divorce is executed before the bid duration ends.

18. The method of claim 17 further comprising:
if the policy owner has executed the divorce before the bid duration ends, issuing a sum of deposits deposited by the policy owner so far in the asset management account to a beneficiary designated by the policy owner; and
when the bid duration ends, terminating the marriage insurance contract.

19. The method of claim 15, wherein calculating the amount of the deposit to be paid by the policy owner or processing the deposit according to the marriage insurance contract and whether the policy owner has executed the divorce further comprises:
if the policy owner changes to execute the divorce, the policy owner has placed the bid in the self-determined interest platform, and the bid does not satisfy the winning bid criterion, issuing a sum of deposits deposited by the policy owner so far in the asset management account to a beneficiary designated by the policy owner, and terminating the marriage insurance contract.

20. A marriage obligation fulfillment insurance system comprising:
a balance settlement module for receiving an insurance premium and deposit according to a marriage insurance contract;
an insurance premium management module for processing the insurance premium according to whether the policy owner has executed a divorce;
a self-determined interest platform for determining a cost of capital and comparing a bid placed by the policy owner in the self-determined interest platform with the cost of capital to determine if the bid satisfies a winning bid criterion;
a joint account management module for processing the deposit and managing a joint account according to the deposit, a virtual account number of the policy owner in the joint account, whether the policy owner has executed the divorce, whether the bid satisfies the winning bid criterion, whether interest of the policy owner should be prepaid, and whether a bid duration of the self-determined interest platform where the policy owner pays the bid amount and bids has ended;
an asset management module for managing an asset management account wherein the asset management account is for depositing a total amount of a winning bid which satisfies the winning bid criterion; and
an event confirmation and compensation module for issuing an insurance benefit corresponding to the insurance premium, a sum of deposits deposited by the policy owner in the joint account, or an amount accumulated in the asset management account to a beneficiary designated by the policy owner according to information provided by the insurance premium management module, joint account management module and asset management module;
wherein the cost of capital is determined according to reference capital supply, capital demand, interest rate, and short- and long-term interest rate variations of the self-determined interest platform.

21. The system of claim 20 further comprising:
a server for coordinating information and financial transactions exchanged between each module of the system and the self-determined interest platform;
an electronic insurance certificate application module for receiving an electronic insurance certificate application from the policy owner and issuing an electronic insurance certificate to the policy owner;
an insurance policy application module for receiving a policy application including the electronic insurance certificate;
a certification module for certifying the policy application and verifying a financial status and debt-clearing capability of the policy owner;
an electronic policy issuing module for issuing an electronic policy to the policy owner wherein the marriage insurance contract is recorded in the electronic policy;
a guarantor and collateral management module for receiving credit information or a collateral provided by the policy owner, calculating a credit amount, and verifying if the credit amount is not smaller than a required bidding amount before placing the bid in the self-determined interest platform;
a user interface for transmitting information between the policy owner and the server; and
a database for storing information according to the information and financial transactions exchanged between each module of the system and the self-determined interest platform.

22. The system of claim 20 wherein if the policy owner has executed the divorce, the event confirmation and compensation module issues the insurance benefit to the beneficiary according to relevant information provided by the insurance premium management module; if the policy owner has not executed the divorce, the balance settlement module receives the insurance premium.

23. The system of claim 20 wherein if the policy owner has not placed the bid in the self-determined interest platform, and the interest has been pre-paid, an amount of the deposit is Uₙ−IUₙ; wherein n is a term number of a current bid in the self-determined interest platform, Uₙ is an upper bid limit of an nth term in the self-determined interest platform, IUₙ is a lower bid limit of the nth term in the self-determined interest platform.

24. The system of claim 20 wherein if the policy owner has placed the bid in the self-determined interest platform, the bid satisfies the winning bid criterion, and the interest has been paid, determine the total amount of the winning bid by:
Aₙ=(Uₙ−Iₙ)×(N−n)+Uₙ×(n−1);
wherein n is a term number of a current bid in the self-determined interest platform, the policy owner wins the bid in an nth term; Uₙ is an upper bid limit of the nth term in the self-determined interest platform; Aₙ is the total amount of the winning bid in the nth term; N is the total terms of the bid duration, and n is smaller than N; Iₙ is the amount of the winning bid of the policy owner in the nth term; and
wherein an amount of a reimbursement is Uₙ.

25. The system of claim 20 wherein if the policy owner has placed the bid in the self-determined interest platform, the bid satisfies the winning bid criterion, and the interest has not been paid, determining the total amount of the winning bid by:
$${A}_{n} = {U}_{n} \times ( N - n ) + {U}_{n} \times ( n - 1 ) + {\sum }_{i = 1}^{n - 1} {IS}_{i}$$
wherein n is a term number of a current bid in the self-determined interest platform, the policy owner wins the bid in an nth term; Uₙ is an upper bid limit of the nth term in the self-determined interest platform; Aₙ is the total amount of the winning bid in the nth term; N is the total terms of the bid duration, and n is smaller than N; ISᵢ is a bid deposited by the policy owner in the self-determined interest platform in an ith term, and i is smaller than n; and
wherein an amount of a reimbursement is Uₙ+Iₜ, and Iₜ is a bid bidden by the policy owner in the nth term.
